(19) United States
(12) Patent Application Publication
(10) Pub. No.: US 2005/0248549 A1
(43) Pub. Date: Nov. 10, 2005

(54) Hand-held haptic stylus

(76) Inventors: Paul H. Dietz, Hopkinton, MA (US); Darren L. Leigh, Belmont, MA (US); William S. Yerazunis, Acton, MA (US); Johnny Chung Lee, Pittsburgh, PA (US)

Correspondence Address: Patent Department;Mitsubishi Electric Research Laboratories, Inc., 201 Broadway, Cambridge, MA, 02139, US

(21) Appl. No.: 10/840,748

(22) Filed: May 6, 2004

(51) Int. Cl. G09G 5/00

(52) U.S. Cl. 345/179

(57) ABSTRACT

Touch screen interfaces suffer from a visual-motor conflict when the user attempt to interact with a virtual object but experiences no physical sensations resulting from that interaction. This can result in uncertainly and decrease performance as well as overall satisfaction with the interface. We introduce a method and device that resolves these issues in stylus-based interfaces for both single and multi-user environments by providing individualized haptic and acoustic feedback. This is achieved by adding a mechanical actuator and acoustic generator to each stylus. These are controlled to respond appropriately to virtual objects and are capable of simulating a variety of physical sensations. Because the feedback is generated by the stylus rather than the screen or touch surface, the current invention can operate at the individual level even in the presence of multiple simultaneous users.

### FIELD OF THE INVENTION

This invention relates generally to haptic devices for human interaction with graphical user interfaces, and more particularly to hand-held haptic devices.

### BACKGROUND OF THE INVENTION

Haptics refers to the use of physical feedback in an interactive system. Often haptic feedback is used to simulate the reactive physical forces caused by the presence of virtual objects in an interactive environment.

Providing tactile or haptic feedback for graphical user interfaces has been known for some time, particularly in the field of assistive technologies and rehabilitation engineering. That work has focused on making computer systems more accessible to those with motor or visual impairments.

Other systems provide tactile feedback in computer interfaces for users. Technologies used include vibration-capable mice, or fully tactile displays using large actuator arrays. However, most of those systems are inappropriate for use with touch-sensitive or tablet-based displays.

Providing tactile feedback for touch screens has been achieved by placing a physical actuator directly behind the touch surface of the display device. That technique is effective for small devices such as PDAs or palm-top computers, but does not scale well to larger screen sizes. Additionally, that technique cannot provide individualized feedback for multi-user touch systems.

One example haptic system is the ‘Phantom’ from SensAble Technologies, U.S. Pat. No. 6,084,587. That system requires an armature mechanism, which substantially increases both the cost and complexity of the system. Similar types of haptic feedback devices have been provided with a variety of electromechanical techniques. Typically, a mechanical armature or system of arms is used to constrain a motion of a tip of the stylus. However, that type of device is typically designed to resist the motion of an attached stylus interacting with a virtual surface in three dimensions.

Another class of prior art haptic devices includes various types of vibrations system used in training or entertainment simulators. Those devices include electromechanical components that provide physical sensations for a significant event that occurred during the simulation or game. These physical sensations are typically transmitted through a handheld controller, a steering wheel, a seat, or an enclosed simulator housing, such as a cockpit.

The following are some U.S. patents that describe prior art haptic device, U.S. Pat. No. 6,445,284, Cruz-Hemandez, et al., Electro-mechanical transducer suitable for tactile display and article conveyance, U.S. Pat. No. 3,919,691, Noll, Tactile Man machine communication system, U.S. Pat. No. 4,044,350, Tretiakoff et al., Electromechanical transducer for relief display panel, U.S. Pat. No. 4,414,984, Zarudiansky, Methods and apparatus for recording and or reproducing tactile sensations, U.S. Pat. No. 6,184,868, Shahoian, et al., Haptic feedback control devices, U.S. Pat. No. 6,084,587, Tarr, et al., Method and apparatus for generating and interfacing with a haptic virtual reality environment, U.S. Pat. No. 6,037,927, Rosenberg, et al., Method and apparatus for providing force feedback to the user of an interactive computer simulation, U.S. Pat. No. 6,686,906, Salminen, et al., Tactile electromechanical data input mechanism, U.S. Pat. No. 6,667,738, Murphy, Touch screen overlay apparatus, U.S. Pat. No. 6,686,911, Levin, et al., Control knob with control modes and force feedback, U.S. Pat. No. 6,211,861, Rosenberg, et al., Tactile mouse device, U.S. Pat. No. 6,429,846, Rosenberg, et al., Haptic feedback for touchpads and other touch controls, U.S. Pat. No. 5,184,319, Kramer, Force feedback and textures simulating interface device, U.S. Pat. No. 6,166,723, Schena, et al, Mouse interface device providing force feedback, U.S. Pat. No. 6,676,520, Nishiumi, et al, Video game system providing physical sensation, U.S. Pat. No. 6,641,480, Murzanski, et al, Force feedback mechanism for gamepad device, U.S. Pat. No. 6,636,197, Goldenberg, et al., Haptic feedback effects for control, knobs and other interface devices, U.S. Pat. No. 6,680,729, Shahoian, et al., Increasing force transmissibility for tactile feedback interface devices, U.S. Pat. No. 6,078,308 Rosenberg, et al., Graphical click surfaces for force feedback applications, and U.S. Patent Application 20030174121, Poupyrev, et al., Mobile apparatus having tactile feedback function.

### SUMMARY OF THE INVENTION

The present invention is a hand-held haptic-feedback stylus for enhancing the interaction with stylus-based input devices. The invention can be employed in single-user as well as multi-user environments due to the individualized feedback design. In the preferred embodiment, the stylus has three major components, a location system, a physical feedback system, and an audio feedback system.

### BRIEF DESCRIPTION OF THE DRAWINGS

FIG. 1 is a diagram of a hand-held haptic stylus according to the invention;

FIGS. 2A and 2B are see-through diagram of two embodiments of the stylus according to the invention;

FIG. 3 is a diagram describing a longitudinal behavior of actuation that provides the haptic feedback according to the invention;

FIG. 4 is a diagram of a graphical user interface that can be used with the stylus of FIG. 1; and

FIGS. 5A-5B are diagrams describing actuator control signals used by the invention.

### DETAILED DESCRIPTION OF THE PREFERRED EMBODIMENT

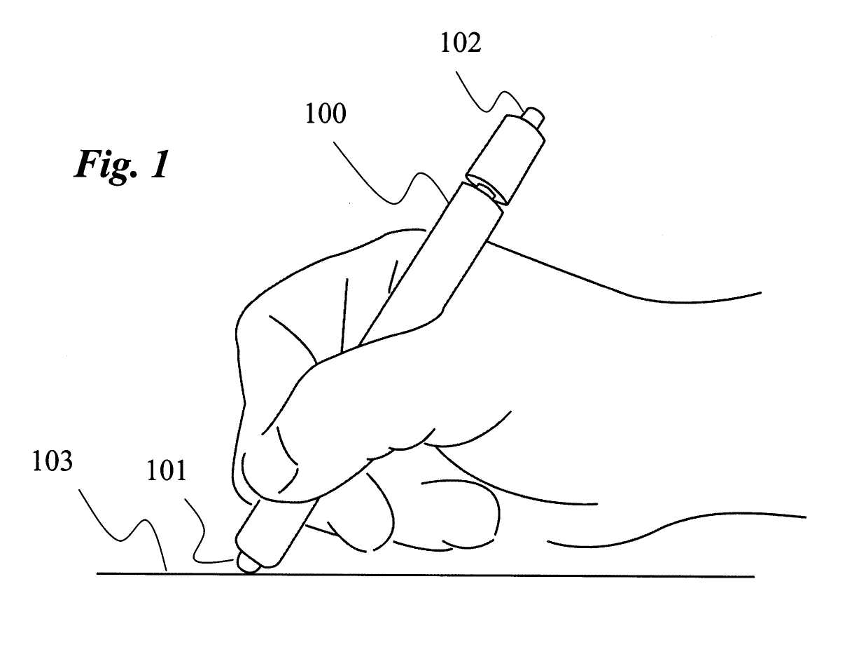

FIG. 1 shows a hand-held haptic stylus 100 according to the invention. The hand-held stylus 100 includes a pressure sensing tip 101 and a linear solenoid actuator 102. The actuator provides physical feedback to a user when the tip of the hand-held stylus is pressed onto a surface 103.

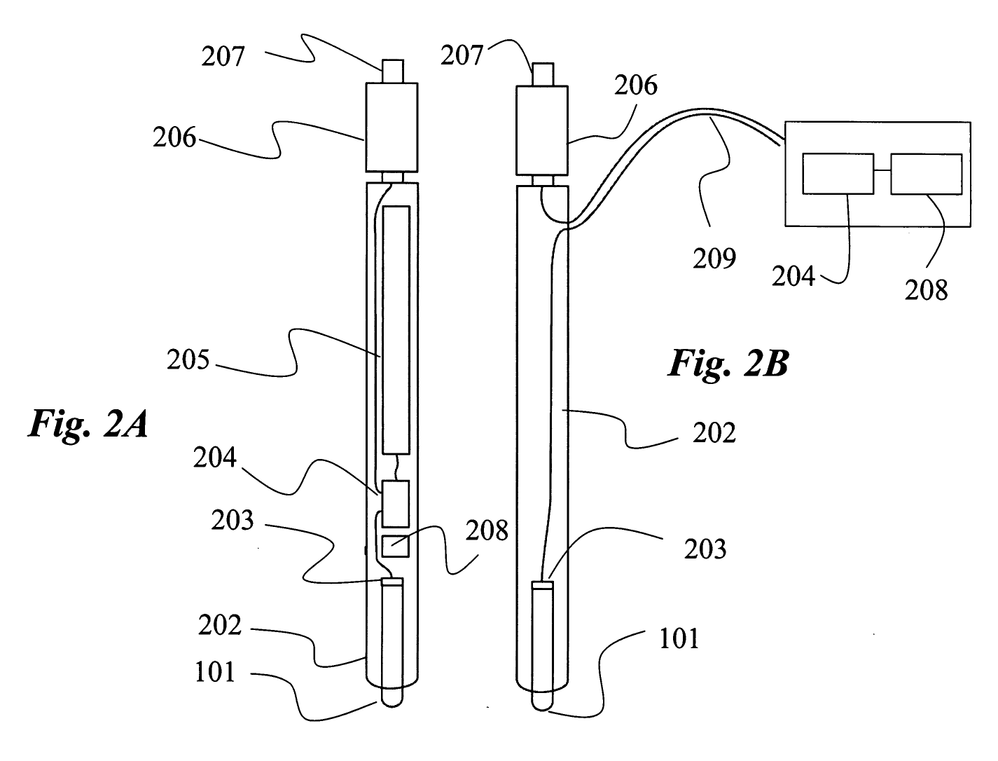

As shown in FIG. 2A, the hand-held stylus includes a cylindrical housing 202 having a first and second end. The tip 101, placed in the first end is in contact with a variable-resistance compression force sensor 203. The tip can move along a longitudinal axis of the stylus. The actuator, placed in the second end of the housing, includes an actuatable mass 206 and a shaft 207 also aligned along the longitudinal axis of the stylus.

A microcontroller 204, e.g., a PIC 16F876, draws energy from a power supply 205. The microcontroller drives the solenoid 102. The microcontroller also digitizes the output of the sensor 203 using a built-in ten bit A/D converter to measure an amount of force sensed by the sensor when the tip of the stylus is pressed on the surface 103. The microcontroller can also communicate with other devices using a RS-232 communications interface. The microcontroller measures an amount of sensed force and actuates the mass 206 accordingly using pulse-width modulation hardware. The stylus can also include a location system 208.

As shown in FIG. 2B, the sensor and actuator can also be connected to the microprocessor and the location system via a tether 209.

The location system 208 determines a location of the stylus when the stylus is in contact with the surface. Sensed locations can be stored in a memory. The location system can include a touch sensitive surface as described in U.S. Pat. No. 6,498,590, Multi-User Touch Surface, incorporated herein by reference. The metal tip 101 provides a conductive channel through the stylus for capacitive sensing with the touch sensitive surface. The specific location of the stylus can also be used to determine the form of force feedback.

The location system used can function over non-planar surfaces, multiple surfaces, or provide more or less than two dimensions of location data. The present invention uses location information as one variable to determine the desired form of force feedback.

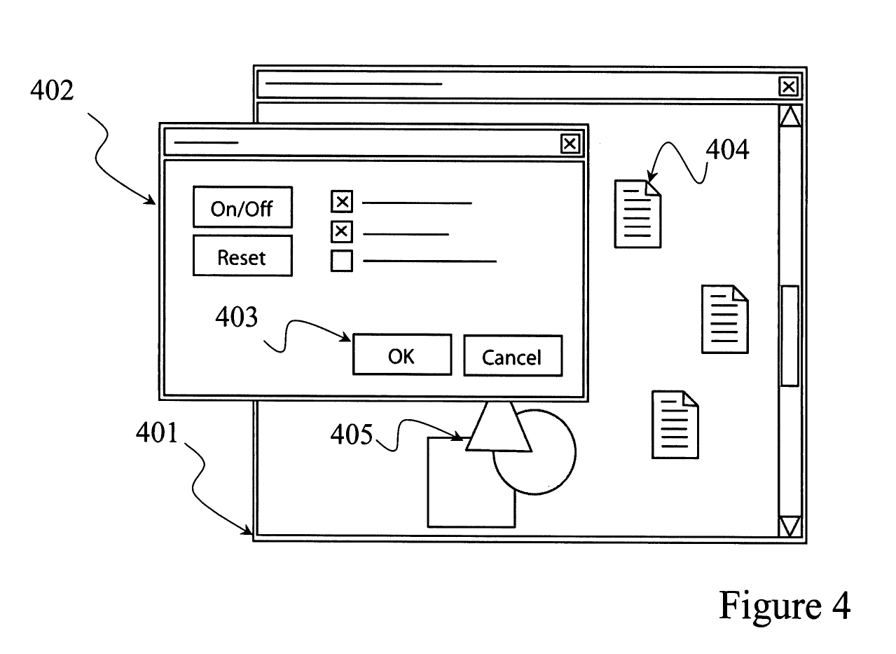

FIG. 4 shows an example application of the present invention that uses the location data with a typical graphical user. The stylus can react or behave differently when moving or being depressed over open regions 401, important edges 402, screen widgets 403, icons 404, or graphical elements 405.

The physical feedback can take many forms. The goal is to produce a physical sensations synchronized and in response to actions of the user holding the stylus. In our preferred embodiment, a mass attached to the stylus is magnetically actuated along the longitudinal axis of the stylus to produce various sensations for the user.

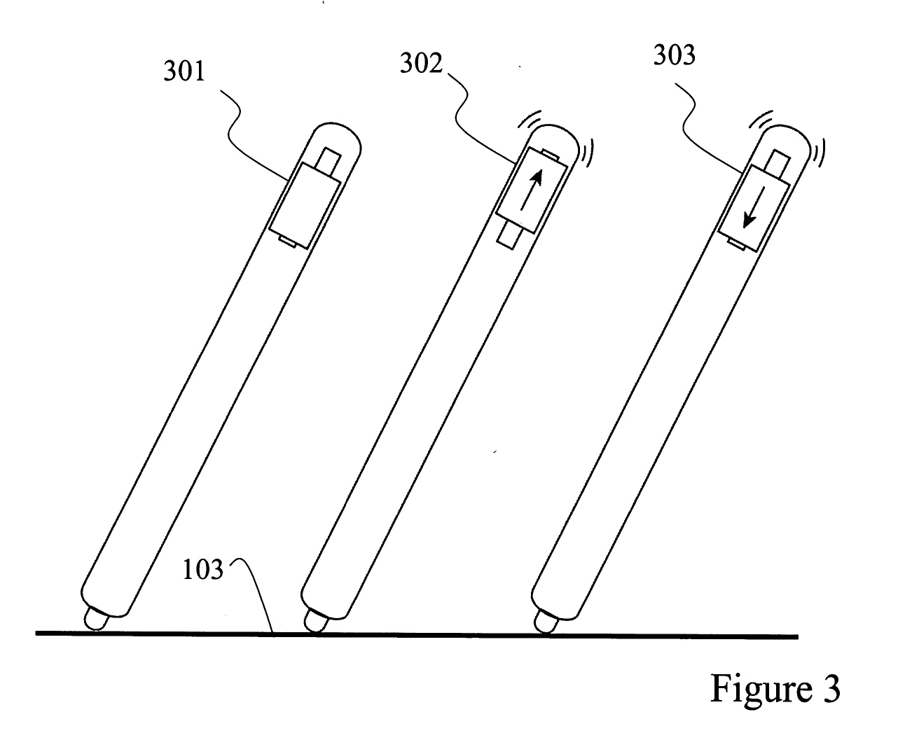

As shown in FIG. 3, the actuated mass can be enclosed inside the casing of the stylus. Beginning in a neutral position 301, the mass can be accelerated away 302 from the tip to provide a primary sensation, as well as accelerated toward 303 the tip providing a secondary sensation. By varying the extent of the acceleration in magnitude, direction, duration, and repetition many different forms of haptic sensations can be generated using this mechanism.

A simulated mechanical button press, or a double ‘click’, such as with a retractable ballpoint pen, can be convincingly generated without actuating the tip itself. The mass can be actuated in a variety of ways to achieve sensations such as, but not limited to, clicking, multi-level clicking, buzzing, squishing, tapping, punching, shaking, cracking, and pushing. The actuation can also be used to simulate surface textures, e.g., bumpy, grooved, slotted, or assist in indicating regions of interest for vision-impaired users or applications.

Tip actuation is also possible. Tip actuation has some advantages. Both mechanisms can produce interesting haptic illusions, including the sensation of pressing a mechanical switch. Unlike the actuated mass that depends upon acceleration to generate a physical sensation, the actuated tip has absolute position control, allowing very slow sensations to be mimicked accurately, as well as sudden sensations. Similarly, the tip can be actuated with a piezo-electric material to provide a high mechanical bandwidth signal for creating a wide range of physical sensations.

The haptic feedback according to the invention should be contrasted with the common prior art rotating eccentric weight used in many so-called “force feedback” systems, such a video game controllers. In those cases, the mechanism provides a physical sensation, but does not attempt to mimic real world physical sensations. A rotating eccentric weight can be used in the stylus, but it cannot produce a sensation like a mechanical button press. Sudden and sharp forces are impossible to generate due to a limited mechanical bandwidth.

In addition to location information, which determines the current type of behavior of the stylus, stylus force information can be used to close the actuator control loop. Our preferred embodiment uses an Inastomer force sensor manufactured by CUI Inc., 9615 SW Allen Blvd., Ste. 103, Beaverton, Oreg. 97005. However, other small, force sensors can also be used.

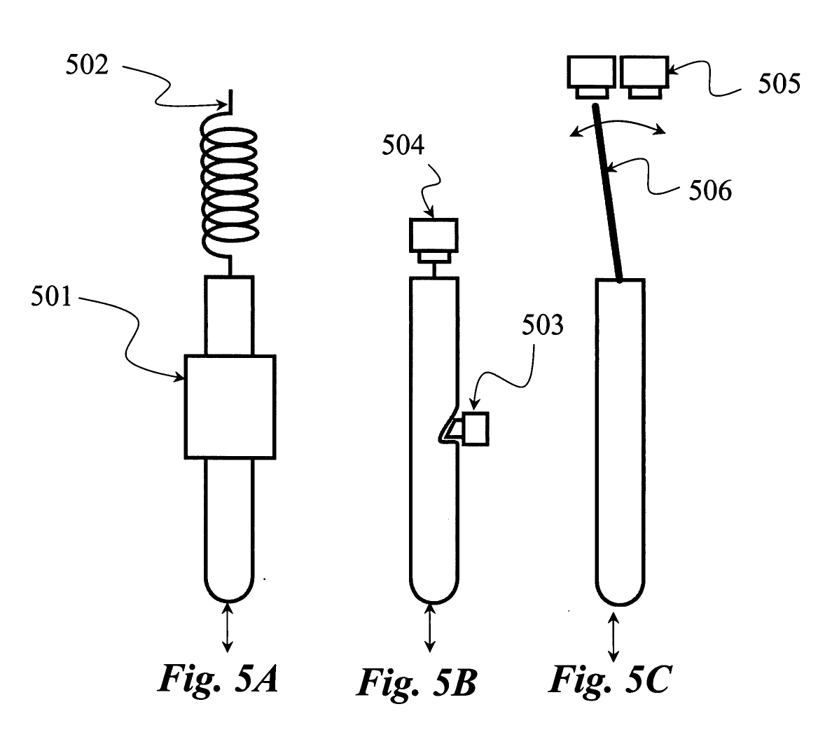

As shown in FIG. 5A, rather than an actuated tip, we can provide a semi-passive system that includes a spring-loaded 502 tip and a simple actuated braking mechanism 501. Using the force sensor, the stylus can be programmed to allow a certain amount of inclusion based on the current applied force. This embodiment can also mimic some range of behaviors.

As shown in FIG. 5B, another embodiment of a semi-passive tip uses a latch 503 and mechanical switch 504 to control physical sensations.

A variant on the semi-passive system that does not require high-speed, detailed force sensing can include a number of mechanical switches 505 that provide different sensations, as shown in FIG. 5C. These are mechanically switched into position via an actuator 506 inside the stylus.

Although stylus-based input displays can include audio output, that audio does not generally emanate from the point of interaction, the stylus. That is particularly problematic in a multi-user environment, where sounds in response to actions by other users can cause confusion.

For this reason, the stylus can include audio output capabilities, in form of a small loudspeaker placed inside the stylus. This allows various clicks and other interface sounds to emanate from the point of interaction, rather than some remotely located audio source. The audio signal can be synchronized to the haptic feedback. Natural audio localization abilities give the user additional cues to aid in identifying interactions from interactions of other users.

Depending upon the actuator mechanism, the actuation itself may generate the acoustic cue. For example, in the preferred embodiment, the longitudinal actuated mass can be arranged to forcefully hit a rigid stop, producing a satisfying auditory ‘click’. However, in environments where ambient noise levels are high or greatly vary, a dedicated sounder or loudspeaker provides the volume control necessary for those situations.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A hand-held stylus, comprising:
a cylindrical housing including a first end and a second end;
a tip placed in the first end, the tip arranged to move along a longitude axis of the housing;
a sensor in contact with the tip;
an actuator placed in the second end; and
means for measuring an amount of force sensed by the sensor when the tip is pressed onto a surface and actuating the actuator to provide physical feedback to a user holding the hand-held stylus.

2. The hand-held stylus of claim 1, in which the sensor is a variable-resistance compression force sensor.

3. The hand-held stylus of claim 1, in which the actuator is a linear solenoid.

4. The hand-held stylus of claim 1, in which the actuator is arranged to move along the longitudinal axis of the housing.

5. The hand-held stylus of claim 1, in which the means for measuring further comprises:
a microcontroller electrically connecting the sensor to the actuator; and
a power supply connected to the microcontroller.

6. The hand-held stylus of claim 5, in which the microcontroller further comprises:
a memory;
pulse-width modulation hardware;
a communications interface; and
an A/D converter.

7. The hand-held stylus of claim 5, in which the microcontroller actuates the actuator according to the amount of sensed force.

8. The hand-held stylus of claim 6, in which the actuator is actuated using the pulse-width modulation hardware.

9. The hand-held stylus of claim 1, in which the means for measuring and actuating are internal to the housing.

10. The hand-held stylus of claim 5, in which the means for measuring and actuating are external to the housing, and further comprising:
a tether connecting the means for measuring and actuating to the sensor and the actuator.

11. The hand-held stylus of claim 1, further comprising:
a location system to determine a location of the hand-held stylus when the hand-held stylus is in contact with the surface.

12. The hand-held stylus of claim 1, in which the tip is electrically conductive, and the location system further comprises:
a touch sensitive surface.

13. The hand-held stylus of claim 11, in which the physical feedback is according to the location.

14. The hand-held stylus of claim 1, in which the surface is planar.

15. The hand-held stylus of claim 1, in which the surface is non-planar.

16. The hand-held stylus of claim 1, in which the surface includes a graphical user interface.

16. The hand-held stylus of claim 1, in which the physical feedback simulates a single click.

17. The hand-held of claim 1, in which the physical feedback simulates a double click.

18. The hand-held stylus of claim 1, in which the physical feedback simulates buzzing.

19. The hand-held stylus of claim 1, in which the physical feedback simulates tapping.

20. The hand-held stylus of claim 1, in which the physical feedback simulates punching.

21. The stylus of claim 1, in which the physical feedback simulates a texture of the surface.

22. The hand-held stylus of claim 1, further comprising:
means for actuating the tip.

23. The hand-held stylus of claim 22, in which the means for actuating the tip is a piezo-electric material.

24. The hand-held stylus of claim 1, in which the tip is spring-loaded.

25. The hand-held stylus of claim 1, further comprising:
means for generating an audio signal while providing the physical feedback.

26. The hand-held stylus of claim 25, in which the audio signal is synchronized with the physical feedback.

27. A method for generating physical feedback in a hand-held stylus, comprising the steps of:
pressing a tip, placed in a first end of the hand-held stylus, onto a surface;
measuring an amount of the force when the tip is pressed in contact with the surface; and
actuating an actuator, placed in a second end of the hand-held stylus, according to the measured amount of force to provide physical feedback to a user holding the hand-held stylus.
